(19) United States
(12) Patent Application Publication
(10) Pub. No.: US 2026/0169836 A1
(43) Pub. Date: Jun. 18, 2026

(54) RECURSION PREVENTION

(71) Applicant: Stripe, LLC, South San Francisco, CA (US)

(72) Inventors: Sivakumar VENUGOPAL, Dublin, CA (US); Adam ELLIOTT, Montreal-Ouest (CA)

(21) Appl. No.: 18/981,436

(22) Filed: Dec. 13, 2024

(51) Int. Cl. G06F 9/54

(52) U.S. Cl. CPC G06F 9/547

(57) ABSTRACT

Aspects of the subject technology provide recursion detection and prevention for automated system calls which are automatically triggered based on events. An automation service can receive an automated request to execute an API call and determine if the automated request was called as a result of an action of a previously executed automated system call. If the automated request to execute the API call was based on a previously executed automated system call, the automated request can be terminated.

### TECHNICAL FIELD

The present description generally relates to preventing unlimited recursion calls in an automated event system.

### BACKGROUND

Programmatic recursions can be used to perform recursive actions. Inadvertent recursions, however, can be problematic and lead to unwanted behaviors. Unbound recursive loops, for example, can cause system resources to suffer and lead to denial-of-service errors. Automated systems can take actions based on an event triggering a preconfigured action for that event.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented, in accordance with one or more embodiments.

FIG. 2 depicts an example electronic device that may implement the subject technology, in accordance with one or more embodiments.

FIG. 3 illustrates a data flow diagram for a workflow server in an automated system receiving an automated request, in accordance with one or more embodiments.

FIG. 4 depicts a flow diagram of an example process for detecting and terminating a recursive automated event, in accordance with one or more embodiments.

FIG. 5 depicts a flow diagram of an example process for processing an automated event and checking for a recursive condition, in accordance with one or more embodiments.

FIG. 6 depicts a flow diagram of an example process for detecting and terminating a recursive automated event, in accordance with one or more embodiments.

FIG. 7 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

Workflow systems can monitor the status of various data sources and/or events and, when one or more events associated with the data sources occur, a condition satisfying to the event can automatically trigger an action. Generally, such workflow systems are available to a system developer who can program such items and ultimately control what actions are automatically triggered and build in programmatic safeguards to ensure that an event will not trigger an action which results in a recursive chain. System developers generally may not allow their customers, such as end users, to program such items.

The workflow systems of the subject technology, however, can provide end users, such as customers of the workflow systems, to access tools that allow the end user to build programmatic relationships between events and system API calls, for example in a block-based programming environment with pre-defined blocks which can be connected together by end users. End users can be provided with tools to connect such event blocks with triggers such that when the conditions associated with the event blocks are triggered, then an action is automatically taken. When end users are given access to such tools, it can be difficult to ensure that one trigger will not inadvertently cause another event to trigger, starting a recursive chain of events and triggers or starting a deep cycle of dependent events, triggers, and automated calls which lead to additional events, triggers, and automated calls.

A direct recursion may occur when an automation triggered by an event makes API calls that generate the same event, therein triggering itself. For example, suppose a user configures an automated process to monitor for an event, Event A, which when detected automatically takes an action, Action A, to execute an automated programming interface (API) call. Then, that API call, when run causes the Event A to trigger, thereby causing Action A to repeat. When Action A is repeated, it again causes Event A to trigger, thereby causing Action A to repeat again. This process can be repeated indefinitely and represents a direct recursion. Indirect recursion may occur when two automations create a loop. In another example, suppose a user configures an automated process to monitor for an event, Event B, which when detected automatically takes an action, Action B. The user also configures an automated process to monitor for an event, Event C, which when detected, automatically takes an action, Action C. Now, Action B is set up in such a way that it triggers Event C and Action C is set up in such a way that it triggers Event B. Thus, when Event B occurs, Action B executes, triggering Event C; then Action C executes, triggering Event B; then Action B executes, triggering Event C; then Action C executes, triggering Event B; and so forth in a recursive process. In some instances, a triggered event may cause a series of events to execute unintentionally. In another example, an Event D can cause Action D to execute, which causes Event E; Event E can cause Action E to execute, which causes Event F; Event F can cause Action F to execute, which causes Event G; and so forth. While this is not a true recursion (that is until, perhaps, Event G causes Action G to execute which causes Event D, Event E, or Event F) the execution of multiple levels of automated actions based on one event may not be wanted.

In the present context, the triggers are generally related to API calls. For example, the event may trigger the automated process to call a particular API configured to be called when that event occurs. It should be understood, however, that the triggers may be related to other activity. For the sake of convenience and simplicity, the triggered activity is generally referred to as relating to an API call, but may be a different activity, such as directly writing a log file, emailing an email account, executing a web link, and so forth. In either case, the API call or activity may cause an event to occur which could trigger another automated process, and so the subject technology applies in both instances.

The risk of runaway load from automation-triggered API calls caused by recursion could have serious consequences, including resource exhaustion, latency, quality of service (QOS) deterioration, denial of service (DOS), inadvertent per use fees accumulated to customers, credit exhaustion so that other workflow processes are not executed, and bad behavior (e.g., repeatedly sending emails or causing a DOS attack on another system). Thus, it is important to detect such events to prevent adverse consequences from occurring as a side effect.

Aspects of the subject technology can determine when a recursion or nested event trigger is occurring and terminate and/or prevent recursive or nested API calls. The subject technology, for example, can track the automated process associated with the event that caused the action to trigger and, determine if the automated process loops. When the automated process loops, the automated process can be terminated and disallowed from continuing to execute. In such an instance, a log can be generated, a user notified, and/or a system designer notified.

In some aspects of the subject technology, nested calls can be prevented or limited to a certain number of nested calls. In such aspects, each of the previous automated processes that caused the action to trigger can be tracked, and if the number of nested calls exceeds a threshold, the automated process can be terminated and disallowed from continuing to execute. A log can be generated, the user notified, and the system designer notified.

Aspects of the subject technology track the triggering event by including a run identifier (run ID) associated with the workflow or automation run that triggered the API call. The triggering event can also be tracked by including a configuration identifier (config 1D) corresponding to the automation configuration, e.g., the event rule set, which was running when the API call was triggered. The run ID and config ID can be considered keys associated with automated process environment which can be used to look up in a persistent log whether a prior parent automated process was used to trigger a current automated process. When an automated event triggers an API call, the run ID and config ID can be checked. If the current automation run being triggered has a preceding parent automation run that triggered the series of events and the config ID matches the parent, then a direct recursion is detected. If the current automation run being triggered has a parent automation run and the config ID does not match, the lineage chain can be traced to determine how many generations of in the chain of runs have been executed. In some instances, if the number in the chain is under a threshold so that the next API call is allowed, the trace of all the run IDs of the each of the parents can be stored prior to executing the next API call.

The recursion prevention system advantageously allows end-users to configure trigger events to execute API calls without having to worry about inadvertent or unexpected recursion events. As noted above, this can prevent potential problems that can arise when indefinite recursion occurs or when deeply nested events and API calls are encountered. The subject technology can therefore prevent a drain on system resources which may be caused by a recursion issue. The subject technology can help prevent bad behavior, for example, by nefarious users or users with stolen credentials who might deliberately create runaway recursive triggers. Further, the subject technology can improve performance of a system in which an inadvertent recursion occurs, at least because it also detects an anomalous condition which can be reported back to the user for rectification, which otherwise may not have been caught. Systems implementing the subject technology can utilize the technology as a backstop for preventing runaway recursion, excessive nested calls, and system lockup or degradation associated therewith.

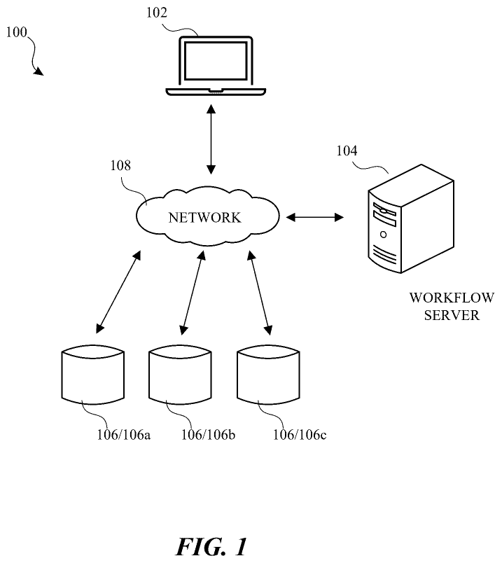

FIG. 1 illustrates an example network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, a workflow server 104, and one or more database servers 106 such as database server 106a, 106b, and 106c. The network 108 may communicatively (directly or indirectly) couple one or more of the electronic devices 102, the workflow server 104, and the one or more database servers 106. In one or more embodiments, the network 108 may be an interconnected network of devices that may include, or may be communicatively coupled to, the internet.

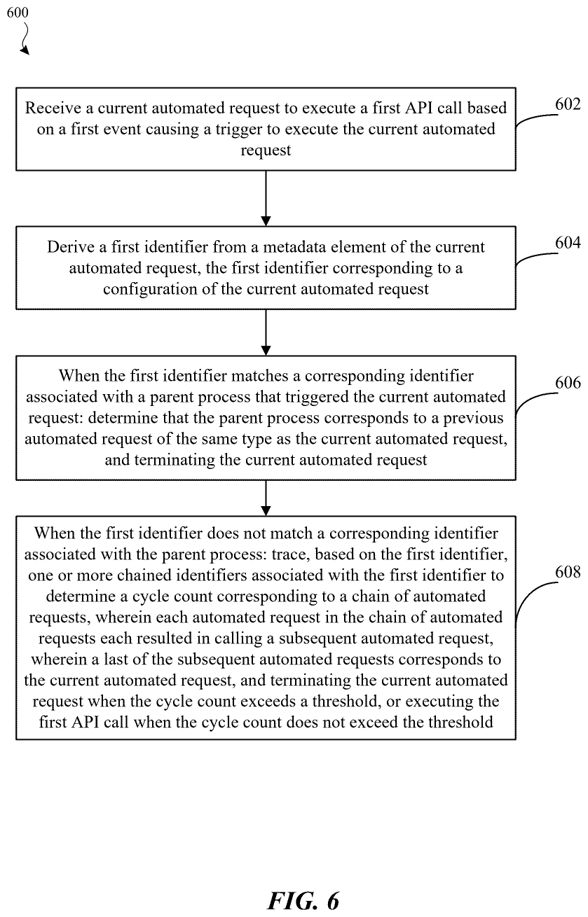

For explanatory purposes, the network environment 100 is illustrated in FIG. 1 as including the electronic device 102, the workflow server 104, and the one or more database servers 106; however, the network environment 100 may include any number of electronic devices and/or any number of servers communicatively coupled to each other directly or via the network 108. In addition, the various systems of FIG. 1 may be, and/or may include all or part of, the electronic system discussed below with respect to FIG. 6.

The electronic device 102 may be under the control of a user with authorization to access records associated with the workflow server 104. For example, the user may be an administrative user associated with the workflow server 104. The administrative user may configure a series of automated tasks based on events and/or triggers associated with the events which may execute various actions, such as performing API calls when a trigger occurs. The electronic device 102, while operating as specified herein. may have authorization to interact with the workflow server 104 and/or the database servers 106, for example, such as through an account login or other access credential. Thus, the electronic device 102 is used to access one or more management applications providing functionality and/or an interface for accessing the subject technology. The electronic device 102 may be, for example, a wearable device (such as a watch, a band, and the like), a desktop computer, a portable computing device (e.g., a laptop computer), a point of service terminal, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a laptop computer. The electronic device 102 may be associated with one or more accounts, credentials, or any other identity information registered with the workflow server 104 and/or the one or more database servers 106, in accordance with some implementations.

The workflow server 104 may be and/or may include, for example, one or more servers that host or facilitate a workflow process that provides an interface to the electronic device 102 for developing automated tasks as described herein. The workflow server 104 can also perform actions associated with the subject technology, such as responding to trigger events and starting automated processes. As an example, the workflow server 104 may include logic for executing a process that determines a trigger has occurred and causes an automated event response to be executed corresponding to the trigger. The workflow server 104 may further include logic for determining if the automated event process is recursive or nested and may take actions to terminate the automated event process. The workflow server 104 may further include logic to log events associated with this process and notify stakeholders when a recursive event is detected and terminated. In some embodiments, the workflow server 104 may be implemented as service of one or more servers. Such one or more servers or the workflow server 104 may be, and/or may include all or part of, the electronic system discussed below with respect to FIG. 6.

The one or more database servers 106 may each be and/or may include, for example, one or more servers that host or facilitate a database service that may be used by one or more entities, and may store and organize data related to the electronic device 102 and/or workflow server 104. The one or more database servers 106 may be implemented as service of one or more servers, such as the workflow server 104, or one or more other servers. Such one or more other servers or the one or more database servers 106 may each include all or part of the electronic system discussed below with respect to FIG. 6.

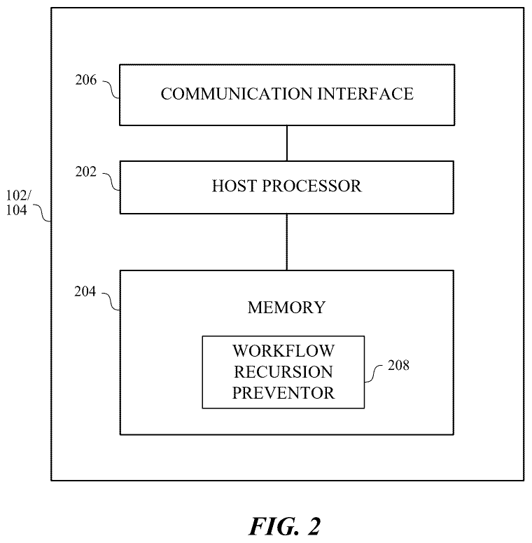

FIG. 2 depicts an example electronic device 102 or workflow server 104 that may implement the subject technology, in accordance with one or more embodiments. For explanatory purposes, FIG. 2 is primarily described herein with reference to the electronic device 102 or workflow server 104 of FIG. 1. However, this is merely illustrative, and features of the server of FIG. 2 may be implemented in any other electronic device for implementing the subject technology and/or any other server for implementing the subject technology, such as the database servers 106. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The electronic device 102 or workflow server 104 may include one or more of a host processor 202, a memory 204, and/or a communication interface 206. The host processor 202 may include suitable logic, circuitry, and/or code that enable processing data and/or controlling operations of the electronic device 102 or workflow server 104. In this regard, the host processor 202 may be enabled to provide control signals to various other components of the electronic device 102 and workflow server 104. The host processor 202 may also control transfers of data between various portions of the electronic device 102 or workflow server 104. The host processor 202 may further implement an operating system or may otherwise execute code to manage operations of the electronic device 102 or workflow server 104.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). The memory 204 may include workflow recursion preventor 208 including executable programs, routines, and services that provide the functions described herein. The specific implemented workflow recursion preventor 208 may vary based on whether the memory 204 is in implemented in the electronic device 102 or the workflow server 104. The memory 204, for example, can include logic and/or programming instructions for implementing part or all of the subject technology corresponding to the workflow recursion preventor 208.

The communication interface 206 may include suitable logic, circuitry, and/or code that enables wired or wireless communication, such as between the electronic device 102, the workflow server 104, the one or more database servers 106. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

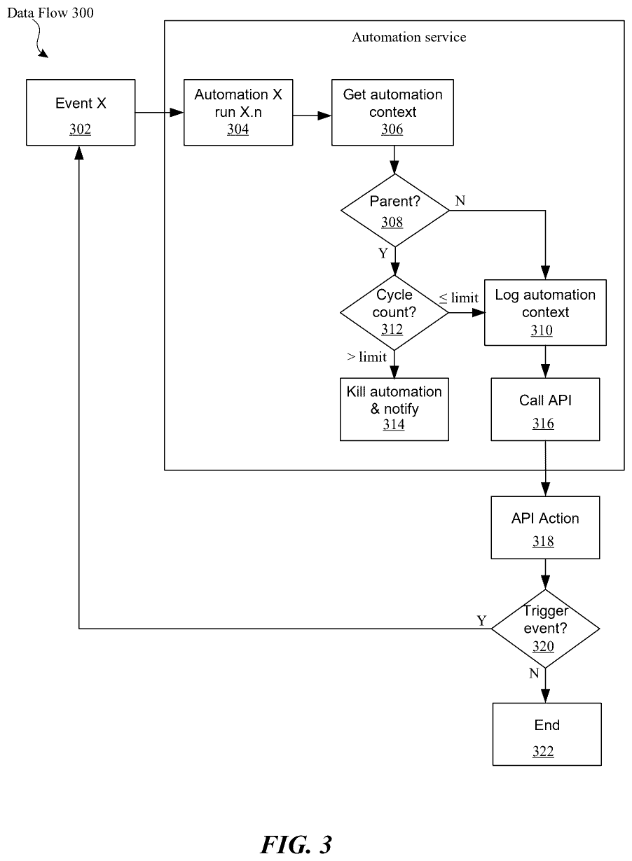

FIG. 3 illustrates a data flow diagram 300 which detects an event which triggers an automation service to run an automation process to execute an API. In this process, the automation process is checked to determine if it is a recursive or deeply nested process and terminated if so. The data flow diagram 300 takes place primarily within the workflow server 104 but may send and/or receive data from the electronic device 102 and from the one or more database servers 106. Although the discussion of the data flow diagram 300 proceeds below describing the data flow from block to block, it should be understood that flow can be performed in parallel as appropriate or may flow out of the order described where the associated processes allow for the data flow to differ. Although specific examples may be used to help elucidate the disclosure, it should be understood that the automated process management described below can be applied to any situation where a user would want to detect and prevent recursion in automated system calls or prevent or reduce deeply nested automated system calls.

At element 302, an event is determined. In this case the event is labeled as “Event X” where X corresponds to an event identifier. The event, for example, may relate to a determination that a condition related to a data source has been met. As an example, the event may be related to an account monitoring process that determines that a transaction with the account exceeds a value. The event may be related to the detection that a data store is nearing capacity. The event may be related to a processing time of another process exceeding a threshold. The event may be related to a power anomaly condition detected at a power supply. In short, in practicality, the event may be related to any computer-related technology or process related to a data source. Event X may trigger an API call in an automation service, as denoted by the box labeled “automation service.”

At element 304, the automation service is triggered by the event (e.g., Event X). In this case, the automation configuration triggered corresponds to the event and is therefore labeled Automation X. It should be understood, however, that X corresponds to a config ID for the automation and that the value for X may be different than the value for X from element 302. The automation service can also assign a run ID related to the specific instance of the automation process which has been triggered. For example, the event triggers the automation service which executes a process for that event. That instance of the process corresponds to the run ID for the automated process. In element 304, the label run X.n is provided which corresponds to a run ID for the configuration, where n is the run ID and X still denotes the config 1D. In some instances, the config ID and run ID can be generated by the automation service prior to executing the target API call (e.g., the API call requested by the event trigger from element 302). The config ID and run ID can be inserted into an API call header (or another metadata element) which is then passed to a process to determine if a recursive API call is being made.

At element 306, as part of determining if a recursive API call is being made (or a deeply nested API call), an automation context can be retrieved. The automation context, for example, can include the config ID and the run ID. In some instances, the config ID and run ID can be extracted from a metadata element, such as a header, which includes parameters for passing to the target API. In addition, the metadata element, such as a header, can specify that the API call was made via an automation event. For example, if the API call was not made via an automation event, the system may optionally skip the process of checking for a recursive condition and the flow could proceed directly to element 316.

At element 308, it can be determined if a parent API call was made. For example, the run ID can be used to determine if it was previously logged in an execution cycle through the automation service. For example, if the run ID was previously logged, then the current cycle is at least the second cycle resulting from an initial event which caused the API call in the first place. In the case where there is not a parent API call logged, then the flow can proceed to element 310, otherwise, if there is a parent API call logged, then the flow would continue to element 312.

At element 310, the automation context, including the config ID and run ID may be logged in a persistent memory space, such as a file or database. Additional details may be logged as well, such as an event descriptor and timestamp. In some instances, when there is a parent API call, each instance of the parent API call can be logged in relation to the immediate parent API call. For example, if the current API call is a fourth iteration, then the immediate parent API call information corresponds to the third iteration, however, the logged automation context may also include the run ID and config ID of the immediate API call, as well as the run ID and config 1D, of each of the previous API calls in the chain. The log information for the automation context can be purged or transferred to long term storage after a timeout period.

Returning back to element 308, if there is parent information, then it can be determined what the cycle count is. In the case where the config ID for the parent is the same as the config 1D as the immediate API call, this can signify a direct recursion and the flow can proceed to element 314. Otherwise, the cycle count can be checked to determine if the cycle count reaches or exceeds a threshold or limit for deeply nested or generational API calls, where the threshold or limit specifies how many cycles deep the API calls may be nested. If the cycle count does not exceed the threshold, then the flow can continue to element 310, where the immediate automation context is logged (and optionally the chain of automation contexts is logged). If the cycle count exceeds the threshold, then the flow can continue to element 314 to terminate the automation process and notify stakeholders of the termination. In some implementations, the threshold may be zero, one, two, three, four, five, six, or seven cycles, though other values are contemplated. For example, if the threshold is zero, then an API call is essentially prevented from calling another API call by way of an automated event which triggers the other API call. If the threshold is one, then one such call would be allowed, and so forth. In the case where the chain of automation contexts is logged, including the automation context of each parent, then the cycle count can be determined by the number of parents in the chain. In the case where only the automation context of the parent of the immediate API call is logged, then the log can be repeatedly referenced to determine the number of parents in the chain, where the number corresponds to the cycle count. For example, if the immediate API call has a parent automation context, and that parent has a parent, and that parent has a parent, then the immediate API call is the fourth API call originating from the initial event of element 302.

At element 314, the automation service can terminate the automation and prevent the API call from being executed. Stakeholders can be notified and/or other actions may also be taken. Stakeholders, for example, can include a customer who set up the event trigger and automated API call or system developers to track recursion events and terminated API calls. Notifications can be made through a message directly to the electronic device 102 or to an email account or other contact mechanism associated with the customer and/or the system developer. The termination can also be logged in a system log file or log database. In some instances, the event can be flagged or modified so that the trigger to execute the API call can be disabled. For example, when an automated process produces many detected recursions, the configuration for that automation can be flagged or disabled to prevent the automated process from executing. Developers can then analyze the automation configuration to determine if it needs to be modified. Upon modification, then the configuration can be reenabled or the flag can be cleared.

At element 316, after logging the automation context, the API call which was requested can be executed. The API call can correspond to the configured action to be taken in response to the event trigger.

At element 318, an action resulting from the API call may occur. The action may correspond to a modification of a data source, a notification or message provided, a movement of data. For example, related to the example events noted above, when the event may be related to an account monitoring process that determines that a transaction with the account exceeds a value, a notification can be provided to a user, a transaction may be denied, or a request for override may be generated, for example. In cases where the event may be related to the detection that a data store is nearing capacity, a new data store can be provisioned, for example. In cases where the event may be related to a processing time of another process exceeding a threshold, the process may be force terminated, for example. In cases where the event may be related to a power anomaly condition detected at a power supply, an alarm may be triggered and/or a work order may be submitted for addressing the power supply. In short, the action may be configured to be related to the event, for example, as a remedy or action taken to address the event condition. In some implementations, the action may be another action which does not appear to be directly related to the event. In short, the system allows for flexibility in calling any API call in response to the triggered event.

At element 320, the API action may trigger another event. If the API action does not trigger another event, then the automation process can end at element 322. It may not be known whether the API action will result in an event trigger that would result in another API call. After a timeout period the automation contexts logged at element 310 can be purged or moved to a long-term data store, for example, at database server 106.

If the API action does trigger an event that would result in a subsequent API call, the flow can continue back to element 302. In such instances, if there was not a parent determined at element 308 for the API call, then a parent will be present for the subsequent API call.

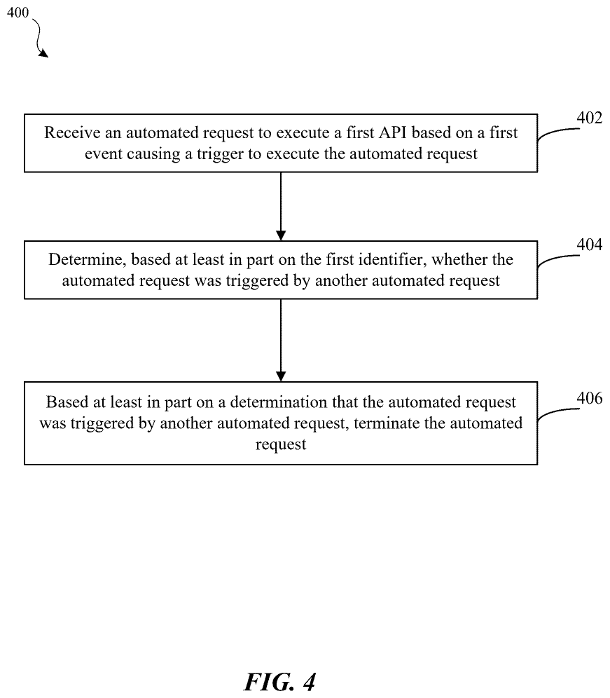

FIG. 4 illustrates a flow diagram of an example process 400 for providing from a server, such as the workflow server 104, a mechanism for processing automated responses to events and determining if a recursion is detected, in accordance with the subject technology. For explanatory purposes, the process 400 is primarily described herein with reference to the workflow server 104. However, the process 400 is not limited to these, and one or more blocks of the process 400 may be performed by one or more other by other suitable devices. Further, for explanatory purposes, the blocks of the process 400 are described herein as occurring sequentially or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, a workflow server can receive an automated request to execute a first API based on a first event causing a trigger to execute the automated request. As noted above, the automated request can result from an event which triggers the automated request to execute the API call. In some implementations, the workflow server can generate or link a config 1D corresponding to the event rule which caused the automated request to be triggered. The workflow server can also generate and provide to the automated request a run ID corresponding to the event process that triggered the automated request. If the event process, for example, was itself from an automated process, then the run ID would correspond to that automated process. In some instances, when the run ID is generated the config ID can be logged along with the run ID in a persistent execution log corresponding to an automation service of the workflow server. The execution log can later be accessed according to the run ID to determine the config 1D, if needed, for example, by extracting the config ID based on the run ID. In some instances, both the run ID and the config 1D may be incorporated into an API call header (or other metadata element) which can be analyzed by a process to determine if a recursion call has occurred or if a deeply nested cycle situation has occurred. In some implementations, block 402 can correspond to element 302 and/or element 304 of FIG. 3. The data sources can be determined based on the request, as described above. Further, the data sources can be scoped or filtered based on the data subjects.

In some implementations, the workflow server can extract from the automated request a first identifier corresponding to the automated request and the first event. For example, the run ID can be extracted from the API call header (or other metadata element) along with the config 1D. Or in the case where the config ID is not available in the header, the config ID can be looked up from a log associated with the automation service of the workflow server. The run ID and/or config ID can correspond to context associated with the requested automated API call.

At block 404 of process 400, the workflow server can determine whether the automated request was triggered by another automated request. For example, the workflow server can determine if the instant API call has another previous API call associated with it as a parent, based on the run ID or other contextual information of the automated API call. In some implementations, block 404 can correspond to element 314 of FIG. 3, described above. The determination in block 404 may be made, for example, based at least in part on the first identifier associated with the automated request.

At block 406 of process 400 the workflow server can terminate the automated request based at least in part on a determination that the automated request was triggered by another automated request. For example, if the parent was triggered by another automated request based on an event resulting from a previous API call, then the automated request can be terminated, and the API call prevented from being executed. In some instances, a cycle count can be used to determine if the number of cycles exceeds a threshold, such that the system may allow some number of deep automated API calling before the automated request exceeds a limit that causes it to be terminated. In some implementations, block 406 can correspond to elements 312 and 314 of FIG. 3.

Process 400 can also include, in some implementations, that the workflow server can perform an action based on terminating the automated request. For example, stakeholders may be notified, and the termination logged. In some implementations, the notification can cause an interruption event associated with the user device, such as a locally generated alert or notification to be provided at the user device. It should be understood that other requests can cause other output to be provided to the user, such as other messages or reports, as described above. In some implementations, the notification can trigger on a user device a physical activation of an actuator to cause a haptic sensation to the user, such as a vibration.

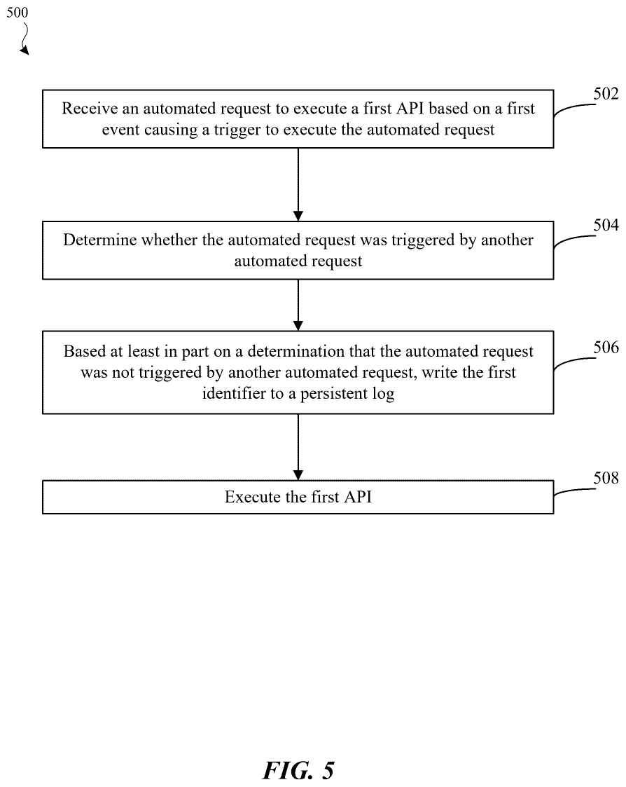

FIG. 5 illustrates a flow diagram of an example process 500 for providing from a server, such as the workflow server 104, a mechanism for processing automated responses to events and determining if a recursion is detected. For explanatory purposes, the process 500 is primarily described herein with reference to the workflow server 104. However, the process 500 is not limited to these, and one or more blocks of the process 500 may be performed by one or more other by other suitable devices. Further, for explanatory purposes, the blocks of the process 500 are described herein as occurring sequentially or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, process 500 may include receiving an automated request to execute a first API based on a first event causing a trigger to execute the automated request. This block may correspond to block 402, described above.

At block 504, process 500 may include determining, based at least in part on the first identifier, whether the automated request was triggered by another automated request. This block may correspond to block 404, described above.

At block 506, process 500 may include, based at least in part on a determination that the automated request was not triggered by another automated request, writing the first identifier to a persistent log. For example, when a recursion is not detected or does not exceed a threshold for cycle counts, the API call will be allowed to proceed. In such instances, however, the first identifier can be written to a persistent log to track a potential chain of subsequent API calls which may be triggered based on the execution of the instant API call. Logging the first identifier, for example, as part of logging automation context for the automated API call, can be used by a subsequent API call triggered by an action resulting from the API call. In some implementations, block 506 can correspond to element 310 of FIG. 3.

At block 508, process 500 may include executing the first API. In some implementations, block 508 can correspond to element 316 of FIG. 3.

The process 500 may further include, in some implementations, that the first API call results in a second event causing a second trigger to execute a second automated request to execute a second API call. In some implementations, the second API call is the same as the first API call, and the second API call is terminated prior to execution, because a recursion is detected. In some implementations, the second API call is different than the first API call, and the second API call results in a third event causing a third trigger to execute a third automated request to execute a third API call. In such implementations, the third API call may be a nested API call which is allowed. In some implementations, the third API call is the same as the first API call or the second API call, wherein the third API call is terminated prior to execution. In such implementations, the third API call is recursive of either the first API call or the second API call and is therefore terminated. In some implementations, the third API call exceeds a cycle count for a number of deeply nested API calls triggered by the first event and based on the third API call exceeding the cycle count, the third API call is terminated prior to execution. In such implementations, it should be understood that any number of intervening API calls may occur before the third API call which ultimately exceeds the cycle count.

FIG. 6 illustrates a flow diagram of an example process 600 for providing from a server, such as the workflow server 104, a mechanism for processing automated responses to events and determining if a recursion is detected, in accordance with the subject technology. For explanatory purposes, the process 600 is primarily described herein with reference to the workflow server 104. However, the process 600 is not limited to these, and one or more blocks of the process 600 may be performed by one or more other by other suitable devices. Further, for explanatory purposes, the blocks of the process 600 are described herein as occurring sequentially or linearly. However, multiple blocks of the process 600 may occur in parallel. In addition, the blocks of the process 600 need not be performed in the order shown and/or one or more blocks of the process 600 need not be performed and/or can be replaced by other operations.

At block 602 of process 600, a current automated request may be received to execute a first API call based on a first event causing a trigger to execute the current automated request. This block may be similar to block 402, described above.

As also shown in FIG. 6, block 604 of process 600 may include deriving a first identifier from a metadata element of the current automated request, where the first identifier corresponds to a configuration of the current automated request. The first identifier, for example, may correspond to the config ID or another ID that indicates the configuration of the automated request which was triggered. For example, these configurations may relate to an automated process handler that monitors event conditions associated with automated requests and initiates an automated request when an event condition is satisfied. The first identifier therefore may correspond to an identification of a particular API which is requested to be called as a result of the event which triggers the automated request, in this case, the first API call. The metadata element may correspond, for example, to a header provided with the API call or may correspond to another type of data structure which information can be passed along with the API call. For example, the API call may include a header structure which can include customized fields for passing relevant information to the API call. In some instances, the first identifier may be passed as information in the metadata directly, while in other instances, the first identifier may be derived or looked up from a table or database entry, for example, or some other storage element that associates a run identifier of the process that triggered the automated request. For example, when the process that triggered the event makes the automated request, an identifier corresponding to the API call (e.g., the current automated request) may be logged along with a runtime identifier or process identifier (i.e., run ID) of the process triggering the automated request. The log can be accessed to determine based on the run ID, which config ID corresponds to the current automated request.

Accordingly, process 600 can also include in some implementations that deriving the first identifier comprises: extracting a second identifier from the metadata element associated with the current automated request, the second identifier corresponding to a run identifier of the parent process that triggered the current automated request; and deriving the first identifier from a log entry associated with the second identifier.

In some implementations, the metadata element can correspond to a header for the API call, the process 600 can also include parsing the metadata element to extract the first identifier and a second identifier, where the second identifier corresponds to a run identifier of the parent process that triggered the current automated request. The process can further include generating a hash including the first identifier and the second identifier. The hash can be provided to an automated event manager. The automated event manager, for example, can handle various aspects of logging and/or performing notifications or tracking calls, as needed. For example, if the system allows a customer a particular number of automated requests, the automated event manager can track the customer's usage.

At block 606 of process 600, when the first identifier matches a corresponding identifier associated with a parent process that triggered the current automated request, process 600 can include determining that the parent process corresponds to a previous automated request of the same type as the current automated request, and terminating the current automated request. For example, if a corresponding first identifier (e.g., config 1D) of the parent process is the same as the config ID of the current automated request, then it can be determined that the current automated request is a direct recursive call from the same type of automated request. In other words, it can be determined that the requested API call is the same as the API call that resulted in the requested API call. In such cases, the current automated request can be terminated to avoid a direct recursive call. Alternatively, the current automated request may be allowed to execute despite the direct recursive call and a certain number of recursive calls can be allowed, whether they are called from the same automated API call or a different automated API call.

At block 608 of process 600, when the first identifier does not match a corresponding identifier associated with the parent process (or if block 606 is not executed and the first identifier does match and instead the process determines an action based solely on the depth of a number of recursive automated calls), process 600 can include: tracing, based on the first identifier, one or more chained identifiers associated with the first identifier to determine a cycle count corresponding to a chain of automated requests, where each automated request in the chain of automated requests each resulted in calling a subsequent automated request, where a last of the subsequent automated requests corresponds to the current automated request; and terminating the current automated request when the cycle count exceeds a threshold; or executing the first API call when the cycle count does not exceed the threshold. The chained identifiers may include a chain of automated API calls. For example, a chain may include the first identifier for the current automated request, a second identifier for a parent automated request that triggered the current automated request, a third identifier for a grandparent automated request that triggered the parent automated request that triggered the current automated request, and so forth. In the case, where the first automated request was the grandparent automated request, then the current automated request would be the third recursively called automated request. This is an example of an indirect recursion, where the actual API call is not of concern, but that the number of automatically generated calls which are called by other automatically generated calls is controlled. So, if the limit was two recursive calls, then this third automated request (e.g., the current automated request) would be terminated prior to being called. Put another way, the chain of identifiers may show that automated call A triggered automated call B, which triggered automated call C. The cycle count is three. If automated call C is the current automated call in this example, and the limit is two, then the current automated call would be terminated prior to taking the requested action (i.e., executing the first API call in this example). If the limit is greater, then the automated call C can proceed.

The chained identifiers can be determined by accessing a log to trace the chain back to the first automated request. For example, the recursion prevention system can access a persistent log according to the current automated request run ID (the run ID of call C) to obtain the parent automated request run ID (the run ID of call B). Based on the parent automated request run ID, the recursion prevention system can access the log to obtain the grandparent automated request run ID (the run ID of call A). Based on the grandparent automated request run ID, the recursion prevention system can access the log to determine that the grandparent automated request (call A) was not called by another automated request (i.e., that it was triggered by an event that was not originated from an automated request).

Accordingly, process 600 can further include that tracing the one or more chained identifiers includes: obtaining a first key corresponding to the parent process from a persistent log based on a second identifier extracted from the metadata element; and obtaining a second key corresponding to another parent process of the parent process from the persistent log based on the first key. It should be appreciated that this process can be continued until a first automated request (i.e., originating automated request) is determined.

In another implementation, each time the current run ID is logged in such a persistent log, the parent run ID (if any) can be logged with it to develop a single chain of run IDs. For example, when the second automated process logs its parent run ID, it can include the parent run ID and its own run ID, for example, in a concatenated field. Then, when the third automated process logs its parent run ID, it can copy the concatenated field and add its own run ID to it. In such a way, the trace of run IDs can be included in a single access of the log file, which may improve performance by reducing the number of log accesses.

Accordingly, process 600 may also include obtaining a second identifier from the metadata element; obtaining a chain of one or more keys corresponding to the chain of automated requests from a persistent log based on the second identifier; appending the second identifier to the chain of one or more keys; and prior to executing the first API call, generating and logging a run identifier for the first API call and the appended chain of one or more keys in a persistent log, where the run identifier is associated with the appended chain of one or more keys. In such instances, obtaining the chain of one or more keys can include obtaining a second identifier from the metadata element, the second identifier corresponding to a run identifier of the parent process that triggered the current automated request; and obtaining a chain of one or more keys from a persistent log based on the second identifier, where each key in the chain of one or more keys represents a prior automated request in the chain of automated requests.

Process 600 can also include that prior to executing the first API call, the process can include generating and logging a run identifier for the first API call and a configuration identifier corresponding to the current automated request in a persistent log. For example, a run identifier can be assigned to the first API call and logged along with the configuration identifier of the current automated request.

Process 600 can also include in some implementations that upon terminating the current automated request, determining a termination count corresponding to a number of times an automated request associated with the first identifier; and when the termination count exceeds a second threshold, suspending an ability to generate the automated request associated with the first identifier. When an automated request is terminated, because a recursive condition was detected, it may be important to investigate the automated request. For example, each time an automated request is terminated, the config ID for the automated request can be logged and a count maintained or derived from the log of terminated requests. If the number of terminated automated requests exceeds a threshold value, the system can suspend the ability for an event to generate that automated request. In such instances, developers may be notified so that they can investigate why recursive automated requests are occurring and may alter the corresponding API associated with the terminated automated request. The threshold can be based on a count for all the available APIs which can be automatically called. For example, the threshold could be set at twice the average of the number of terminated automated requests for each API call. For example, if automated requests for one API call exceeds twice the average of the API calls or of the other API calls, then the ability to automatically call that API may be disabled. In another aspect, prior to automatically suspending the ability to call an API, an API may be flagged at another threshold. For example, if automated requests for one API call exceeds one standard deviation of the number of terminated automated requests for each API call, then the API call can be flagged and then suspended after three standard deviations, or the like. It should be appreciated that thresholds may be dynamic using any suitable statistical characteristic or static or may be adjustable by system developers. Accordingly, process 600 may include flagging an automated request in a library of automated requests (e.g., API calls available to be called automatically) based on the first identifier.

Process 600 may also include notifying the user that set up the automated request trigger of the termination of the automated request upon termination. Accordingly, process 600 may include obtaining a second identifier from the metadata element, the second identifier corresponding to a run identifier of the parent process that triggered the current automated request; upon termination of the current automated request, logging the termination of the current automated request by storing the first identifier and the second identifier in association with the termination; and notifying a user of the termination of the current automated request. The user, for example, may be a user of the electronic device 102, and the notification may be a message or alert sent to the electronic device 102. The notification may be an email, text, or message in a user interface for the user, for example, provided by an interface server associated with the workflow server 104.

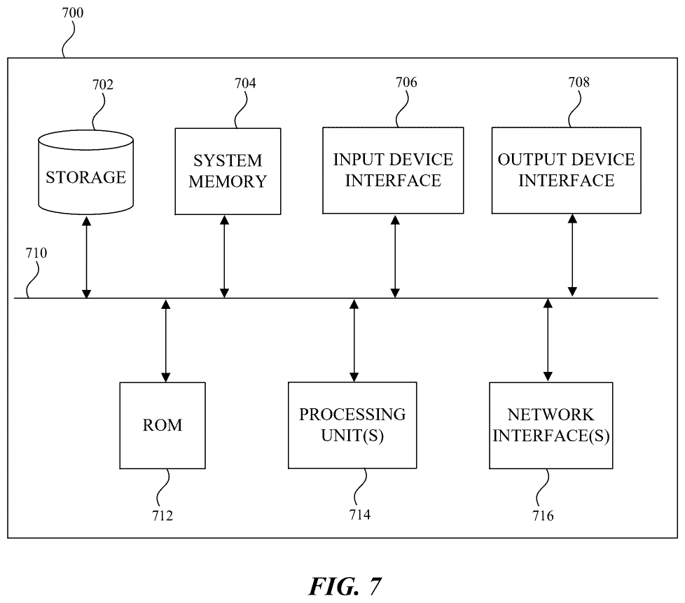

FIG. 7 depicts an example electronic system 700 with which aspects of the present disclosure may be implemented, in accordance with one or more embodiments. The electronic system 700 can be, and/or can be a part of, any electronic device for generating the features and processes described in reference to FIGS. 1-8, including but not limited to a laptop computer, tablet computer, smartphone, and wearable device (e.g., smartwatch, fitness band). The electronic system 700 may include various types of computer-readable media and interfaces for various other types of computer-readable media. The electronic system 700 includes one or more processing unit(s) 714, a persistent storage device 702, a system memory 704 (and/or buffer), an input device interface 706, an output device interface 708, a bus 710, a ROM 712, one or more processing unit(s) 714, one or more network interface(s) 716, and/or subsets and variations thereof.

The bus 710 collectively represents all system, peripheral, and chipset buses that communicatively connect the numerous internal devices of the electronic system 700. In one or more embodiments, the bus 710 communicatively connects the one or more processing unit(s) 714 with the ROM 712, the system memory 704, and the persistent storage device 702. From these various memory units, the one or more processing unit(s) 714 retrieves instructions to execute and data to process in order to execute the processes of the subject disclosure. The one or more processing unit(s) 714 can be a single processor or a multi-core processor in different embodiments.

The ROM 712 stores static data and instructions that are needed by the one or more processing unit(s) 714 and other modules of the electronic system 700. The persistent storage device 702, on the other hand, may be a read-and-write memory device. The persistent storage device 702 may be a non-volatile memory unit that stores instructions and data even when the electronic system 700 is off. In one or more embodiments, a mass-storage device (such as a magnetic or optical disk and its corresponding disk drive) may be used as the persistent storage device 702.

In one or more embodiments, a removable storage device (such as a floppy disk, flash drive, and its corresponding disk drive) may be used as the persistent storage device 702. Like the persistent storage device 702, the system memory 704 may be a read-and-write memory device. However, unlike the persistent storage device 702, the system memory 704 may be a volatile read-and-write memory, such as RAM. The system memory 704 may store any of the instructions and data that one or more processing unit(s) 714 may need at runtime. In one or more embodiments, the processes of the subject disclosure are stored in the system memory 704, the persistent storage device 702, and/or the ROM 712. From these various memory units, the one or more processing unit(s) 714 retrieves instructions to execute and data to process in order to execute the processes of one or more embodiments.

The bus 710 also connects to the input device interfaces 706 and output device interfaces 708. The input device interface 706 enables a user to communicate information and select commands to the electronic system 700. Input devices that may be used with the input device interface 706 may include, for example, alphanumeric keyboards, touch screens, and pointing devices. The output device interface 708 may enable the electronic system 700 to communicate information to users. For example, the output device interface 708 may provide the display of images generated by electronic system 700. Output devices that may be used with the output device interface 708 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 710 also couples the electronic system 700 to one or more networks and/or to one or more network nodes through the one or more network interface(s) 716. In this manner, the electronic system 700 can be a part of a network of computers (such as a local area network, a wide area network, an intranet, or a network of networks, such as the internet). Any or all components of the electronic system 700 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving a current automated request to execute a first API call based on a first event causing a trigger to execute the current automated request;
deriving a first identifier from a metadata element of the current automated request, the first identifier corresponding to a configuration of the current automated request;
when the first identifier matches a corresponding identifier associated with a parent process that triggered the current automated request:
determining that the parent process corresponds to a previous automated request of the same type as the current automated request, and
terminating the current automated request; and
when the first identifier does not match a corresponding identifier associated with the parent process:
tracing, based on the first identifier, one or more chained identifiers associated with the first identifier to determine a cycle count corresponding to a chain of automated requests, wherein each automated request in the chain of automated requests each resulted in calling a subsequent automated request, wherein a last of the subsequent automated requests corresponds to the current automated request, and
terminating the current automated request when the cycle count exceeds a threshold, or
executing the first API call when the cycle count does not exceed the threshold.

2. The method of claim 1, wherein the metadata element corresponds to a header for the first API call, and wherein the header includes the first identifier, further comprising:
parsing the metadata element to extract the first identifier and a second identifier, the second identifier corresponding to a run identifier of the parent process that triggered the current automated request;
generating a hash including the first identifier and the second identifier; and
providing the hash to an automated event manager.

3. The method of claim 1, wherein deriving the first identifier comprises:
extracting a second identifier from the metadata element associated with the current automated request, the second identifier corresponding to a run identifier of the parent process that triggered the current automated request; and
deriving the first identifier from a log entry associated with the second identifier.

4. The method of claim 1, further comprising:
prior to executing the first API call, generating and logging a run identifier for the first API call and a configuration identifier corresponding to the current automated request in a persistent log.

5. The method of claim 1, wherein tracing the one or more chained identifiers comprises:
obtaining a first key corresponding to the parent process from a persistent log based on a second identifier extracted from the metadata element; and
obtaining a second key corresponding to another parent process of the parent process from the persistent log based on the first key.

6. The method of claim 1, further comprising:
obtaining a second identifier from the metadata element;
obtaining a chain of one or more keys corresponding to the chain of automated requests from a persistent log based on the second identifier;
appending the second identifier to the chain of one or more keys; and
prior to executing the first API call, generating and logging a run identifier for the first API call and the appended chain of one or more keys in a persistent log, wherein the run identifier is associated with the appended chain of one or more keys.

7. The method of claim 1, wherein tracing the one or more chained identifiers comprises:
obtaining a second identifier from the metadata element, the second identifier corresponding to a run identifier of the parent process that triggered the current automated request; and
obtaining a chain of one or more keys from a persistent log based on the second identifier, wherein each key in the chain of one or more keys represents a prior automated request in the chain of automated requests.

8. The method of claim 1, further comprising:
upon terminating the current automated request, determining a termination count corresponding to a number of times an automated request associated with the first identifier; and
when the termination count exceeds a second threshold, suspending an ability to generate the automated request associated with the first identifier.

9. The method of claim 1, further comprising:
obtaining a second identifier from the metadata element, the second identifier corresponding to a run identifier of the parent process that triggered the current automated request;
upon termination of the current automated request, logging the termination of the current automated request by storing the first identifier and the second identifier in association with the termination; and
notifying a user of the termination of the current automated request.

10. The method of claim 9, further comprising:
flagging an automated request in a library of automated requests based on the first identifier.

11. A method comprising:
receiving a first automated request to execute a first API call based on a first event causing a trigger to execute the first automated request;
determining whether the first automated request was triggered by another automated request based on metadata associated with the first automated request, the metadata including an indication of a source of the first automated request;
based at least in part on a determination that the first automated request was not triggered by another automated request, writing a first identifier corresponding to a configuration for the first automated request to a persistent log; and
executing the first API call, wherein the first API call results in a second event causing a second trigger to execute a second automated request to execute a second API call.

12. The method of claim 11, further comprising:
writing a second identifier to the persistent log, wherein the second identifier corresponds to a run identifier corresponding to the first API call.

13. The method of claim 11, wherein the second API call is the same as the first API call, further comprising terminating the second automated request to execute the second API call prior to executing the second API call.

14. The method of claim 11, wherein the second API call is different than the first API call, wherein executing the second API call results in a third event causing a third trigger to execute a third automated request to execute a third API call.

15. The method of claim 14, wherein the third API call is the same as the first API call or the second API call, further comprising terminating the third automated request to execute the third API call prior to executing the third API call.

16. The method of claim 14, wherein the third API call exceeds a cycle count for a number of deep API calls triggered by the first event, further comprising, based on the third API call exceeding the cycle count, terminating the third automated request to execute the third API call prior to executing the third API call.

17. A device comprising:
a storage device; and
a processor executing program instructions stored in the storage device and being configured to:
receiving a current automated request to execute a first API call based on a first event causing a trigger to execute the current automated request;
deriving a first identifier from a metadata element of the current automated request, the first identifier corresponding to a configuration of the current automated request;
when the first identifier matches a corresponding identifier associated with a parent process that triggered the current automated request:
determining that the parent process corresponds to a previous automated request of the same type as the current automated request, and
terminating the current automated request; and
when the first identifier does not match a corresponding identifier associated with the parent process:
tracing, based on the first identifier, one or more chained identifiers associated with the first identifier to determine a cycle count corresponding to a chain of automated requests, wherein each automated request in the chain of automated requests each resulted in calling a subsequent automated request, wherein a last of the subsequent automated requests corresponds to the current automated request, and
terminating the current automated request when the cycle count exceeds a threshold, or
executing the first API call when the cycle count does not exceed the threshold.

18. The device of claim 17, wherein deriving the first identifier comprises:
extracting a second identifier from the metadata element associated with the current automated request, the second identifier corresponding to a run identifier of the parent process that triggered the current automated request; and
deriving the first identifier from a log entry associated with the second identifier.

19. The device of claim 17, wherein the processor is further configured to:
prior to executing the first API call, generating and logging a run identifier for the first API call and a configuration identifier corresponding to the current automated request in a persistent log.

20. The device of claim 17, wherein the processor is further configured to:
obtaining a second identifier from the metadata element;
obtaining a chain of one or more keys corresponding to the chain of automated requests from a persistent log based on the second identifier;
appending the second identifier to the chain of one or more keys; and
prior to executing the first API call, generating and logging a run identifier for the first API call and the appended chain of one or more keys in a persistent log, wherein the run identifier is associated with the appended chain of one or more keys.
